(19) United States
(12) Patent Application Publication
(10) Pub. No.: US 2014/0120508 A1
(43) Pub. Date: May 1, 2014

(54) METHOD FOR EFFECTING CHANGES IN AN INDIVIDUAL'S BEHAVIOR OR MENTAL STATE

(71) Applicant: Toby Jensen, Salt Lake, UT (US)

(72) Inventor: Toby Jensen, Salt Lake, UT (US)

(21) Appl. No.: 13/935,543

(22) Filed: Jul. 4, 2013

Related U.S. Application Data
(60) Provisional application No. 61/719,403, filed on Oct. 27, 2012.

(51) Int. Cl. G09B 19/00

(52) U.S. Cl. CPC G09B 19/00
USPC 434/236

(57) ABSTRACT

A method for effecting changes in a subject's behavior or mental state comprising wherein background and preparation work is performed on the subject by engaging the subject in conversation and asking probing questions, getting the subject to the point where the subject feels his or her emotions; and, having the subject feel the emotion the way it wants to be felt.

### CROSS-REFERENCE TO RELATED APPLICATIONS

This application claims the benefit of U.S. Provisional Application No. 61/719,403 filed Oct. 27, 2012, in the United States Patent and Trademark Office which is hereby incorporated by reference herein in its entirety, including but not limited to those portions that specifically appear hereinafter, the incorporation by reference being made with the following exception: In the event that any portion of the above-referenced applications are inconsistent with this application, this application supercedes said above-referenced application.

### STATEMENT REGARDING FEDERALLY SPONSORED RESEARCH OR DEVELOPMENT

Not Applicable.

### BACKGROUND

1. The Field of the Invention

This disclosure relates generally to a method for altering a person's behavior or mental state by dealing with the underlying mental issues that are responsible for driving the individual's behavior. This can include the underlying drivers of a person with mental illness. Thus, this method can be used to deal with long term issues such as schizophrenia, or short term mental issues such as temporary depression.

2. Description of Related Art

Several schools of psychotherapy have developed over the last century and a half to deal with various forms of behavioral issues and mental illness. The earliest and most famous was the form of psychotherapy developed by Sigmund Freud. In this form of therapy, known as verbal psychotherapy, Freud had the subjects talk about their experiences and, based on this, the subjects got in touch with their repressed subconscious and obtained insight into why they were the way they were. This method suffered from the shortcoming of being incomplete and unnecessarily focusing on the negative.

Another form of treatment was developed by Carl Jung and was based on the connection between psychotherapy and spirituality. The principal concept was that people's repressing the dark side of their nature was causing them problems. Jung viewed the human psyche as “by nature religious.” One of the focuses of his method of treatment was in the field of dream analysis and symbolization. As he was fond of saying “The gold is in the dark.”

Individuation is the central concept of Jung's method. Jung considered individuation, a psychological process of integrating the opposites, including the conscious with the unconscious while still maintaining their relative autonomy, to be necessary for a person to become whole. One of the shortcomings of Jung's method is that what one focuses on tends to expand in importance. Thus, if one focuses on the dark side of one's personality, it can become overpowering. The seductiveness of the dark side gives us permission to give in to our mental illness and it can keep people from really dealing with their problems.

Yet another form of psychoanalysis is known as Interpersonal Psychoanalysis. Interpersonal psychoanalysis accents the nuances of interpersonal interactions, particularly how individuals protect themselves from anxiety by establishing collusive interactions with others, and the relevance of actual experiences with other persons developmentally (e.g. family and peers) as well as in the present.

All of the above therapies suffer from the shortcoming that they make the assumption that there is not a cure for the mental issues afflicting the patient. They generally tend to teach coping mechanisms rather than cures. Therapy sessions can therefore go on for decades as the patient tries to deal with issues that never fully resolve.

Other forms of therapies fall into the category of techniques to change habits. In these therapies, the person wishing to change is simply exhorted to change his or her behavior. The theory behind these is that if one changes one's actions then one can change one's internal motivations. The programs developed by Steven R. Covey and Tony Robbins fall into this category. They essentially treat the symptoms rather than the disease.

It would be useful to have a method to reliably deal with mental issues by resolving the underlying mental issue that is causing the symptoms rather than just dealing with the symptoms. The following disclosure relates to such a system. This disclosure relates to a method that is broader and more effective than the means currently being used to treat mental conditions such as depression or mental illness, or methods aimed simply at changing behavior. This disclosure relates to changing behaviors by changing an individual's beliefs that stem from critical experiences in that individual's life. As a consequence, this method can impact people in many different contexts—from people suffering from mental illness to people wanting to improve sports performance or improve business profits or to improve their performance in politics or the entertainment industry, just to name of few examples.

Being able to change behavior permanently by changing the mental processes underlying that behavior changes the whole game of life across the planet. The ability to cure mental illness is only one aspect of dozens of applications. Of course, the change needed for something as complex and sensitive as schizophrenia is far more difficult to effect than the change needed to enjoy exercising. And, many more people throughout the world would benefit from electing change every day on a small scale than the number of people needing help in resolving mental illness.

The key to the system is the concept that many mental issues and illnesses are the result of false beliefs developed by the individual in response to emotional and often traumatic events. For example, a person who experiences a traumatic event may draw the conclusion from it that the traumatic event happened to them because they are a bad person and “deserved it.” This is a false belief because a negative experience does not necessarily have to generate negative feelings. Just as when good things happen to a person, that person generally feels good even if the good thing that happened was completely arbitrary and not the result of any direct action by the person.

The feelings that an individual develops as the result of an event will be unique to that individual and will vary greatly from the feelings another individual might develop as the result of experiencing a similar event. Everyone responds to trauma uniquely. Some people develop PTSD as the result of a traumatic event and some don't. This is because each person's mind can take a different lesson or belief from the event. The current method encourages the subject to examine the feelings they experience as a result of the traumatic event and to explore what those feelings are trying to tell or to teach that individual. Ultimately, the lesson will be a positive lesson rather than the negative lesson that the person has been attributing to the experience. Once the subject experiences the positive lesson, he or she will be able to have more powerful positive feelings and without being affected by the negative emotions and behavior that result from the negative feelings surrounding that event.

### SUMMARY

The current disclosure teaches an integral multi modal applied system for dealing with mental issues (or regular change) that is more effective than the currently existing individual methods. The method is based on helping the person with the issues change the false beliefs that are at the root of his or her problem. This is accomplished by the person feeling the feelings that are being generated by the false beliefs and having the person get in touch with those feelings to learn from them to be able to change.

One of the reasons that this is such a difficult profession is because the practitioner tends to attract subjects that have the same problems the practitioner has. See Newton's Third Law. Like attracts like. It's not enough that the practitioner can help people, now the practitioner has to help people from his or her weakest position. As you work from your weakest state you are humble and delicate in doing just what needs to be done.

It's not a facilitator's job to fix people because only they can fix themselves. It's the facilitator's job to assist the subject in being able to fix themselves. They're 100% responsible for themselves and their lives. The facilitator is a steward. Psychology wants to be smart and do it all for them sometimes by being intellectually superior in telling them why they are doing what they are doing. Providing insight for an individual can be helpful but it often doesn't lead to a cure. It often leads to dependency on the psychologist. In the past, coping skills have been used the majority of the time in therapy with the therapist spending his or her time during each session processing the subject to achieve significant improvement. Now that a cure has been found, this job has been forever changed. Since we now have a cure, the profession of psychology and the field of personal development has forever been changed it two major ways. We no longer have to spend time figuring out what to do. We now need salespeople (motivators, public speaking, personal development gurus such as Tony Robbins) to talk us into actually wanting to do our personal inner work. And, secondly, we need life coaches to teach skills once we are healed. The majority of the focus of therapy can shift from figuring out how to heal to actual healing.

This development is bigger than curing all mental illness. This is how to change, not just curing mental illness, but about being able to change even to our deepest core level. Being able to change any behavior is a far more of a powerful underlying development that impacts people across all aspects of life—from mental illness to professional sports to improving business profits to politics to the entertainment industry. Being able to change permanently changes the whole game of life across the planet. The ability to cure any mental illness is only one aspect of dozens of applications. After all, being able to change anything is far more powerful and broad than the specific change required for mental illness. Of course, the change needed for something as complex and sensitive as schizophrenia is a far more difficult than a simple change to enjoy exercise. Many more people throughout the world apply change every day on a small scale than the number of people needing help in mental illness.

### BRIEF DESCRIPTION OF THE DRAWINGS

The features and advantages of the disclosure will become apparent from a consideration of the subsequent detailed description presented in connection with the accompanying drawings in which:

FIG. 1 is a flow chart of the system.

### DETAILED DESCRIPTION

At the outset, it should be appreciated that while the present disclosure is described with respect to what is presently considered to be exemplary embodiments, it is understood that the disclosure is not limited to the disclosed embodiments.

Furthermore, it is understood that this disclosure is not limited to the particular methodology, materials, and modifications described and as such may, of course, vary. It is also understood that the terminology used herein is for the purpose of describing particular aspects only, and is not intended to limit the scope of the present disclosure, which is limited only by the appended claims.

Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the preferred methods, devices, and materials are now described.

At the outset, it must be stressed that the heart and soul of the process is as follows: Thoughts control our feelings. Feelings control our behavior. Our behavior produces results. Results prove our thoughts are correct. Any point of this sequence can lead to any other point.

Our feelings are the most powerful gateway to permanently changing our thoughts i.e.—our beliefs. Our feelings are thus the key to being able to change at the deepest level. The ultimate goal of the process is to get the subject to feel the feeling fully as powerful and as painful as it is to then open the doorway to have the chance to access change.

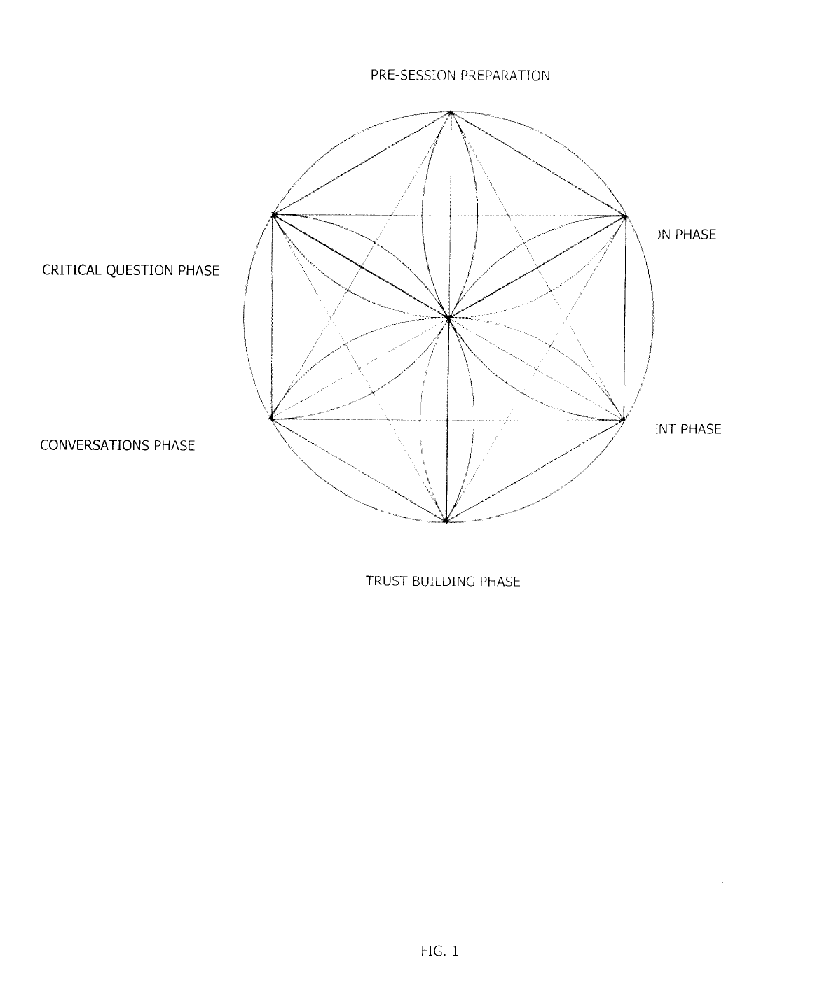

FIG. 1 depicts a flow chart showing a set of steps for implementing the method. There are numerous modifications in technique that may be made depending on the individualistic personality of the subject.

### Education Phase

The first step in practicing the method is the education phase. In this phase, the person practicing this method, hereinafter referred to as the facilitator, becomes familiar with the various techniques contained in the following sources:

1. The Dark Side of the Light Chasers by Debbie Ford—This is essentially Carl Jung's ideas simplified. This body of work recognizes that the dark side of emotions is still part of us. The point of the dark side of emotion is to become whole and responsible for everything and to find joy in learning from the negative.
2. The Shadow Effect by Deepak Chopra, Marianne Williamson and Debbic Ford—This is essentially Carl Jung's ideas simplified. This body of work recognizes that the dark side of emotions are still part of us. The point of the dark side of emotion is to become whole and responsible for everything and to find joy in learning from the negative. It is also used as another type of media other than reading to educate.
3. Crucial Conversations by Kerry Patterson, Joseph Grenny, Ron McMillan and Al Switzler—This work deals with: connecting the inner and outer world, to manifest from the spiritual injecting into the physical how a conversation can change one's reality.
4. The Inner Game of Work by W. Timothy Gallwey; Inner Skiing: Mastering the Slopes Through Mind/Body Awareness by W. Timothy Gallwey; The Inner Game of Golf by W. Timothy Gallwey—These works deal with enjoying the process and still achieving results, tough love and support and the use of self talk to entertain the ego and stay in the flow to enjoy producing positive results.
5. Living Your Dreams: Using Sleep To Solve Problems and Enrich Your Life by Gayle Delaney—Teaches affirmations used to help direct your intention just before you fall asleep to begin lucid dreaming.

### 6. A Brief History of Everything by Ken Wilber.

7. Generations: The History of America's Future, 1584 to 2069 by William Strauss and Neil Howe—Teaches techniques similar to DiSC.
8. The Power of Now by Eckhart Tolle and A New Earth: Awakening to Your Life's Purpose by Eckhart Tolle—Teaches about eliminating the ego and getting into the present moment through techniques such as breathing exercises. Also teaches techniques that allow one to look just beyond words and get at the intended meaning behind the words and the space between the words to see where the words are pointing to by focusing on not just the words, but the tone, feeling, body language, and pictures all said at once.
9. Feel the Fear and Do It Anyway by Susan Jeffers—Teaches techniques to resist temptation and to temporarily suppress emotion only for short term results.
10. Zen and the Art of Motorcycle Maintenance by Robert M. Pirsig—Teaches teaching with a theme and stepping off into the void.
11. The Alchemist by Paulo Coelho—Teaches teaching with a story.
12. Ender's Game by Orson Scott Card—Teaches learning from unlikely sources and that truth can be found in strange places if one understands what it actually being said.

### 13. The Alcoholism & Addiction Cure: A Holistic Approach to Total Recovery by Chris Prentiss.

14. The Awakening workshops taught by Gary Acevedo.
15. NLP Behavioral Modeling—deals with learning body language accurately in the way they learn to read microexpressions.
16. Socratic questioning methods, especially those employed in sales techniques
17. Carl Rogers—person centered therapy
18. Fritz Pearls—gestalt and cognitive behavioral therapy (CBT)
19. Albert Ellis—changing beliefs
20. Carl Jung—dark side of the soul with spirituality
21. John Gray and Allison Armstrong—male/female dynamics.
22. DiSC Personality Profiling (Myers-Briggs, Wealth Dynamics. etc.)—A DiSC assessment is a quadrant behavioral model that examines the behavior of individuals in their environment or within a specific situation. The assessments classify four aspects of behavior by testing a person's preferences in word associations. DiSC is an acronym for:

Dominance—relating to control, power and assertiveness;

Influence—relating to social situations and communication;

Steadiness—relating to patience, persistence, and thoughtfulness; and

Compliance—relating to structure and organization:

23. Minnesota Multiphasic Personality Inventory (MMPI), Hartman Value Profile and other tests to determine actual mental health status.

Because the method taught in this disclosure is interactive and the specific concepts employed will vary depending on the personality type and communication style of the particular subject, a knowledge of the techniques set forth in the above sources are essential to be able to evaluate the manner and extent to which each of the following steps should be employed.

### Pre-Session Preparation

The first part of the pre-session Preparation phase is essentially a Sales process. A salesman's most powerful tool is questions. Thus, in this phase, the practitioner asks the subject questions aimed at obtaining the subject's motivation and demonstrating to the subject that there is a positive reward in engaging in the process. The practitioner is offering a subject a specific way to obtain their desired positive healthy reward without the negative aspects that have traditionally accompanied it. When you offer the positive payoff without the negative action previously used to get it then you begin to get their attention. For example, in one instance the practitioner might ask, “How would you like to have your current alcoholic husband's love without the beating and abuse?” In other words, enjoy love and save the marriage without the abuse? With another person, you might ask. “How would you like to have success without the perceived negative aspects of the success?” Show that it's enjoyable, relaxing etc.

The second part of the pre-session phase is the intake part. This consists of an assessment of the person's particular problem and the underlying causes. Also, we determine whether there is any physical affliction. This might involve an examination by a doctor. In other words, in the intake phase, the practitioner determines why the subject is engaging in a particular behavior and determining whether there is any There is any medical problem causing it?

After the intake, all of the above books are sent to the subject. Before the next session, the subject is required to read the dust jacket of each book. As part of the homework, the subject is required to bring questions regarding any unresolved concerns about the process and the anticipated outcome. For example, how they think it should work, questions about the practitioner and what to expect.

Display how to cure anger as an example. Explain that curing anger does not mean that the subject will never get angry again. It simply means that the subject will no longer inappropriately display anger. The treatment prevents anger from getting out of control. The subject can control it.

### Assessment Phase

The next step is the Assessment Phase. In the assessment phase, a person's suitability for help at any particular time is gauged based on his or her desire to know something about where their illness has come from. There are particular types of problems and types of people who are especially suited for being facilitated. Someone who is not suitable for help expresses no desire to know more about help with their illness. To be successful with this method, the person requesting help must demonstrate a desire to start the process. The person wishing to start the process must have some capacity for speech and communication. As well, they need to be able to have or develop trust during the session.

Thus, potential subjects must undergo a preliminary stage evaluation to assess his or her amenability to being facilitated, and also to enable the person delivering the method to form a working personal model which the person receiving the method will use to implement the method. The key is to start with the subject's symptoms and work backwards using the techniques contained in the sources set forth above.

In one embodiment, the person facilitating the method asks the subject at least one question from the following list: what therapy or personal growth has the subject already done, where is the subject currently at in their work, what is the subject's personal history; what is the subject's relationship history; what is the subject's work history; why is the subject seeking help; what problems is the subject experiencing; what symptoms is the subject experiencing, what help does the subject need; and, how does the subject feel the facilitator can help him or her.

The person facilitating this method then listens to the responses. These responses suggest other questions that the person facilitating the method might ask. The particular follow up questions and techniques to discover more about the subject are based on the techniques set forth in the sources set forth above.

This assessment may also be performed using the DiSC personality assessment. The facilitator determines which quadrant the person fits into. The facilitator makes an assessment of how to deal with them based on the DiSC assessment. For example, it tells the facilitator where the subject lies within the following eight critical categories: emotional states, their goals, how they judge others, how they influence others, their value to the organizations they belong to, what they overuse, and how they react under pressure.

In another embodiment, the assessment includes offering the subject the prospect that submitting to this procedure will result in a payoff without a negative payoff. This proposal gets the subject's attention. For example, if one of the manifested problems is a husband's alcoholism, you might ask the wife, “How would you like to have your current alcoholic husband's love without the beating and abuse?” or “How would you like to enjoy love and save the marriage without the abuse?”

The goal of this is to try to get the person to explore and express his or her feelings. The person implementing this method gauges how responsible the subject is and what kind of “racket” are they running. What is meant by this is that the problem the subject expresses as the reason they are seeking help is often not the real problem. This is generally because they are so invested with the real problem, that they don't want to give it up, even when they are aware of it and therefore, express the problem as really being the result of something else. For example, the subject may express the problem as being a problem with the people around him or not understanding them or not being accepting of them. This is usually an expression of the fact that the subject has a problem with himself or herself and is projecting the problem onto the people around him or her based on the subconscious understanding that if they confronted the fact that the problem is theirs, they would have to deal with the problem. This is an unwelcome task because they are so emotionally invested in the problem.

At this point, the person facilitating this method tries to develop some preliminary impressions regarding why the person is doing what they're doing and especially with regard to whether there are any medical problems causing the behavior.

The person facilitating the method may also perform a verbal DISC assessment. The person facilitating this method may also perform a written DISC assessment as well.

Based on the results of the assessments set forth above, the person facilitating the method will determine: who the subject is; where the subject is in terms of what their bad experiences were; where the subject is now; what does the subject's future look like based on where they are now assuming and not using this system.

The person facilitating this method then makes a determinative conclusion based on the assessment: In this determinative conclusion, the person facilitating this method determines how much work it is going to take and how much work the subject is willing to do; the probability of the length of the process, the probable outcome and the probable best method or methods for carrying out the process especially with regard to the trust phase and the critical question phase. The person facilitating this method will also establish the subject's expectations at this time.

The final stage of the assessment phase is to prep the subject for the first session. This comprises providing books to the subject that the subject will need to read in order to prepare for the next set of sessions, and asking the subject to the read the books, or selections from the books and to bring questions for the next session.

### Trust Building Phase

The facilitator then proceeds with the trust building phase. The trust building phase generally comprises carrying on a conversation with the subject. Certain techniques are employed during the course of these conversations that come from the sources set forth above. For example, one exercise in the earliest parts of the trust building phase is the breathing exercise. Breathing is one of the easiest and most effective ways to return to the present moment. In this exercise, the subject is instructed to take a deep breath and let it out all at once in rush or nice and slowly. As the subject releases the breathe he or she tells himself or herself to relax. Relax into the breathe release. This is a common yoga technique that allows the person to exist in present moment as long as the subject feels himself calming down and staying relaxed while he feels himself breathing. In the present moment there is no mental illness. In the present moment there are no problems. In the present moment the subject is the healthiest being possible. In the present moment the subject is able to deal with problems in the most effective manner. The subject is now asked to compare how they were before breathing to how much more relaxed they are now. This perception of improvement in their state begins a sense of trust in the subject.

The techniques employed in the trust phase include: expressing an empathic attunement to the subject; conveying interest in what the subject is saying; speaking with the subject in terms that convey warmth or acceptance; exposing a bit of the facilitator's personal life or attitudes to the subject; allowing the subject autonomy in the form of disagreement with the facilitator; and explaining the motivations of others which the subject misperceives.

Ask the subject the qualifying questions. These are general discussions that lead to statements that lead to follow up questions. At the same time the person facilitating can offer insights into the subject's feelings and behavior with the goal of and keeping the discussion going and keeping the subject coming back. With women, the person facilitating the method might just listen and to help them feel better. With men, the person facilitating the method may give them coping skills.

The trust phase can take several one to two hour sessions. If done properly, the subject should gradually open up and reveal more and more about his or her life and experiences. The person facilitating should encourage this with the various trust building techniques learned from the sources set forth in step one above so that the subject continues to respond positively to the input in a general positive feedback loop. The subject should, at the end of these sessions, be regularly responding in a manner that indicates that they feel safe.

### Crucial Conversation Phase

The Crucial Conversation Phase of the process comprises a series of discussions that work through emotional difficulties the subject is experiencing with the goal of bringing about positive lasting change. The Crucial Conversation Phase comprises 7 steps. Each step builds onto the ones before it. It is essentially a relationship building process. The person facilitating the process grows the relationship with the subject by integrating more healthy ways of living into the subject's life and developing techniques in the subject to enable the subject to deal with the negative in a healthy way. The steps comprise the following:

Step 1—CARING. The person practicing this method must communicate to the subject that the person facilitating the method cares about the subject. This is similar to Carl Rogers' person centered therapy, and involves self disclosure by the person facilitating the method to connect to the subject.
Step 2—GETTING TO KNOW THE SUBJECT—Get to know the subject on a personal level. Part of this involves assessing the subject's responsibility level. This stage also involves determining if the subject is masculine or feminine as well as reviewing their behaviors in light of the results of the DiSC profiling. If the subject is a woman, the person facilitating the method might want to begin a feeling based discussion. Women tend to feel their feelings better by talking them out. Hold her heart. Hold her feelings in your focus. Enter into her heart (starts with holding her heart), listening to her feelings, sharing her feelings to unload and be validated.

If the subject is a man then the discussion can take on a more action orientation. Men tend to feel their feelings better internally rather than talking about them. They tend to communicate their feelings nonverbally. So they are felt by others. Talking about events or what to do or reflective periods to give a man private time to process feelings internally privately.

In addition, the person practicing this method must be in tune to body language and learn to understand what the subject really means and listen to what they are trying to communicate including the intended meaning behind the words and the space between the words to see where the subject's words are pointing too. Communicating in words alone is a poor form of communication. The highest form of communication is words, tone, feeling, body language, and pictures all said at once.

Step 3—SAFETY PHASE. The person practicing this method must assess whether the subject is safe enough to deal with the problem. Often a person exhibiting irresponsibility or being a victim will never be completely safe. No one is ever completely safe. It works much better when the subject is safe enough.

Also, the balance of how the subject wants to be treated (healthy and unhealthy) with the healthy way to treat them. The techniques taught in The Inner Game books—Focus, Learning, Pleasure, and Mobility are useful here as they teach how to enjoy the process and still achieve positive results.

Step 4—RESPONSIBILITY. The person practicing this method must encourage the subject to be responsible for what he or she did without blaming them. Begin answering their questions, clarifying, and checking their understanding.
Step 5—SHARE THE FACTS. If questions are answered then start doing the process. Ask them what they want to work on. Then as trust builds through responsible safety and real results then more difficult things are released by the subconscious to work on. Connect the inner and outer world and explain how a conversation changes a person's reality, facilitating out loud.
Step 6—UNDERSTAND THEIR SIDE. Why does the subject do what he or she is doing?Also, determine where the subject is lying, either to the person facilitating the method or to himself or herself. (Feminine is done in discussion) Masculine can be done in reflective meditation)
Step 7—SOCRATIC QUESTIONING. The subject is asked many questions such as “How do you feel about what happened?How else does the subject feel about it?” The whole point of this phase is to encourage the subject to feel emotion to learn what it really wants for him or her. Feeling the emotion and communicating with it is quite similar to gestalt therapy as well as Carl Jung therapy combined with emotionally focused therapy dealing in dealing with negative emotion.

As the subject begins this process, the subconscious filter immediately recognizes that what the subject is doing do will work. And then it immediately begins to feed the subject the emotions in exactly the way they need to be felt. The subject's job is to responsibly feel the emotions to get what they really want the subject to know. In other words once the subject starts to heal a beginning emotion that the subject is currently feeling, it can begin to change and allows other emotion to reveal themselves that also need to heal. It us up to the subject to feel out these emotions in the way that they want to be felt in order to be healed. It can be very difficult because the negative emotions are already deeply trained to be destructive in action. This can obviously be very distractive, to say the least. At worst they can be completely overwhelming with a pain so immense the person will do anything to not feel them. Start with what they are currently feeling.

Then as the subject becomes better at healing and growing with the beginning emotion then the subject's subconscious may release even bigger darker emotions depending on how much the subject needs to heal. Once the subject has the trust and responsibility to know how to heal then their subconscious may give them even more difficult deeper darker emotions to heal. This is where repressed feelings can begin to come up.

This is not to be confused with dark emotions that a person may think they have so they go looking for those to heal them and find them because they just created them. It works much better to simply go with what they are feeling right now (or maybe strongly in the recent past). If you feel your current feelings just how they want to be felt then things will shift (often rather quickly) to other feelings to be felt and healed. Sometimes all it has to teach you is to turn away from it so it doesn't hold you hostage.

The goal is to get people to feel their feelings in a responsible way so that they can get in touch with their feelings in order to change them. It works better that while feeling the negative feeling that the client let the positive feeling message completely into or all the way through the negative feeling to change it. The subject fees the positive feeling coming into the old negative feeling to change it by while holding onto the negative feeling. The client feels the positive message as feeling coming into the old belief and then the client may even feel it as it changes. Let the positive feeling change the negative feeling instead of the client working to change the negative feeling. The work is to hold a channel of connection between the feelings to receive the feeling of the positive message into the negative feeling as the client also holds onto the original negative feeling.

Often times this may be too difficult for someone at first. Towards the beginning, just trusting that there is a positive feeling message can be very helpful—just sit with the possibility that there might be a positive feeling message to experience—can begin to open up the potential for change later. It si also much easier to start with less complex difficult feelings (or smaller problems) at the beginning as long as the individual is feeling them fully and completely, just as the feeling wants to be felt, only in order to open the doorway to be able to get an answer to the question, “what is it you really want me to know?” An additional help is to imagine what the positive feeling message might be that the negative feeling could possibly want you to experience.

### Critical Question Phase

Once the requisite level of trust and acceptance has been established and the subject is responding with the requisite degree of openness, the facilitator then moves the process to the critical question phase. In this phase, the facilitator asks a series of questions aimed at getting at the central events in the subject's past (or the most powerfully emotional events at any time) that are responsible for the subject's false beliefs and behavior. After a certain number of sessions the person facilitating the method begins to ask questions about what the subject is willing to deal with in terms of his or her past and assessing the capability of what the subject can handle. The person facilitating the method does this by looking at the subject's body language, tone of voice, fidgeting, etc. Once the subject starts feeling the feeling they may start with their excuses or defense mechanisms—“I don't want to feel this feeling because there is no cure.” The critical question phase comprises instructions (telling the subject to try to say what's on their mind, including interferences); exploration (asking questions); and clarification (rephrasing and summarizing what the subject has been describing).

The goal is always to try to bring the subject around to talking about the experience that is causing the real problem. Talking about the real problem in order to fully experience the had feeling that surrounds the negative experience. At this point the person implementing the method will; tell the subject to “feel the feeling the way it wants to be felt” and tell the subject to: “ask the feeling what it is you want me know.” Once the subject is feeling the feeling as fully as it truly is then the subject asks the feeling (not the event) what it is that it really wants the subject to know. Any version of “What do you really want me to know” is fine to ask. Saying the words of the question is not nearly as important as putting forth the intention of one's sincere desire as a feeling into the negative feeling(s) one wishes to change in order to experience what the feeling has for that person. It works better to ask, instead of demanding. One must ask while surrendering to the feeling to let it tell you anything—anything that is the truth. Any negative answer is not the truth. Keep asking in humility or in surrender even if the weight of the feeling is crushing you. Listen only for the positive answer. When it comes you will be able to recognize the truth of it by instantly beginning to see the previous negative feeling slowly begin to change. You can ask again to confirm. You can review any previous answers as often as you want too. Sometimes the answer doesn't come immediately. Then you have to stay open to receiving an answer and wait. This wait helps you to become stronger to be able to hold to the feeling of the new positive answer. It may even be a war that you are entering into when going through this process. If it does become a war then this will also strengthen you to be able to receive and live from the positive answer. The ultimate answer is always positive.

The subject doesn't necessarily have to go back and relive the event itself. The goal is to have the subject get in touch with his or her feelings about the event in order to access the beliefs. It's very personal to the subject what their mind wants them to learn from the event. The subject is locked into the event because of the subject's false beliefs. By feeling the emotions fully and completely that were initiated by an event (usually negative) the subject is finally able to access the doorway to change. The change can come about by the subject asking the negative feeling (not the event or the characters from the event) a question to direct the outcome in a positive manner. The question “what is it you really want me to know?” is directed into the negative feeling as a sincere desire with the expectation by the subject to receive a more powerful healthy positive feeling. It is usually not in saying the words of the question that will produce change—it is in the intention of projecting a positive sincere desire to humbly receive whatever positive feeling the answer will come in. Or in other words the feeling of asking the question is far more important than saying the words of the question. Now it may even take the subject to still hold onto feeling the negative feeling until the revealing of a positive feeling can happen. By holding onto the negative feeling the subject stays in feeling mode. By feeling the negative the subject can receive the positive feeling. (Without feeling you usually only have a temporary intellectual insight.) This way the subject experiences the more powerful positive feeling in the form of a “lesson”. By feeling the negative feelings exactly the way they want to be felt can the subject then receive the far more powerfully changing positive feelings. There is usually no move into a positive feeling. The positive feeling comes to the subject and “washes out” the false negative belief/feeling. Once the subject feels the more powerful healthy positive feelings they are free from the negative feelings. Transformation has been achieved. They usually feel it immediately.

When the person is not negatively affected by the memory of the event, they do not react in the same way, they react in a positive way (or neutral way). They are cured. The subject now lives life from healthy positive feelings where the negative feelings used to be while recognizing that to be complete and whole negative feelings exist as well. It is at this point that the subject can still remember or know there are negative feelings. It is that these feelings no longer have a negative impact on them anymore.

The order of performing the steps in this part of the process can be changed, and most parts of the process can be done at any time. In addition, not all of the steps must be done. It is more helpful to find the difference between what must be done and what has already been done to date. However, as a general rule, the deeper the belief usually the more feeling is involved to change it permanently. In other words, the deeper you want to take a healthy belief to master it usually the more feeling is involved. And, the more a feeling is, painful to feel you the more you need to deal with it

Simply feeling feelings without acting them out can be very helpful as a coping skill to get started building the emotional strength to deal with it completely later. The danger is that if you get in touch with powerful emotions you may not be able to stop from acting on them so it is more responsible to do it in a place with people that can help be responsible in order to get through it. Central to this idea is that feelings have feelings. The more you experience the emotion by consciously choosing to feel it the way it wants to be felt the more strength and trust you develop in being able to understand as deeply as possible what the emotion wants you to know. By having strength and trust to be able to hold to the new positive “lesson” and understanding you have the ability to grow out the positive intent and live healthy, being healthy, enjoying a positive life while getting your previous unobtainable positive intent without the negative payoff through the negative action. You win when you get the message deeply. You get it deeply by feeling it. Then the positive feeling has the opportunity to grow.

Following the feelings when they change and/or seeing how the feelings are interrelated. Dealing with both sides of the negative emotion: If you start with power hungry control freak then it would eventually lead to submissive powerless abused loser victim in some form or another. Sometimes it is faster, stronger, better just to jump to the opposite right up front. (If the subject is emotionally strong enough and willing and able.)

The key here is finding the right combination of emotion(s) a person needs to deal with. Forcing the feelings, answers, or most parts of the process tends to not be too helpful. Holding to an intention and/or assertively expecting to be able to find the underlying positive intent from a negative emotion tends to get positive results and relief resulting in being more healthy. Projecting what you want the answer to be usually doesn't help to change the belief. People often want to make their own answer up because we are often told we can do anything we want with our lives. We are told we can run our lives anyway we want to so we begin to tell ourselves (tell our feelings) how to behave and what results they are supposed to be getting for us. We become more healthy when we listen to the positive reward that the feelings have for us.

How men do it is usually different than women and both are usually different than how children process. Masculine men usually process through feelings internally, they communicate non-verbally. Feminine women usually process through talking it out with the masculine. Children can have tendencies toward either way.

Feeling the feelings is usually more effective than just intellectually describing them. When you feel the feelings then you have a better chance of feeling and experiencing the underlying positive intent. By experiencing that the feeling it is strong enough to redo your belief pathways which is how you become healed and/or changed. Talking about feelings is not actually feeling our feelings. It can create safety to lead into feeling our feelings. Something can happen in a real conversation where we change. This process describes what that is that happens, how it works, and how to achieve it every time. In an emotionally connected conversation between people life becomes real. When it's real then we stay involved. In real involvement our emotion is connected. Once the emotion is involved then the change can begin to happen. Without an emotional connection the conversation stays at an intellectual level. Core beliefs are at the deepest part of ourselves and are best accessed through responsible emotional connection. Other lighter beliefs may be changed through an intellectual discussion (see Albert Ellis therapy). Skills training can be done on an intellectual level.

Carl Jung's psychology of finding the gold in the dark is instructive here: This involves the conversation with the dark side in order to get what it has over you. So you can learn what it “really” wants you to know. This is the underlying positive intent that you need to get completely in order to be healthy. The dark is only one side of our learning and development. Without involving our learning from the light side we only learn half of reality. Learning from the light side is quite different from learning from the dark or negative emotion. Learning from positive feelings is important because the goal is to enjoy life not just be punished by our negative feelings.

The mentally ill being around healthy people helps them to get better. Standards are set, love is shared, and responsibility is expected without blame. Communication skills (win-win negotiation) are also applied to dealing with feelings, listening to response and whatever else is going on (focused and then big picture to compare). Listening to what you are telling yourself, then dealing with it appropriately.

It's the feeling you are after not necessarily the actual event that caused the problem. Although they do tend to go hand in hand. The traumatic event happened. They were troubled. Then while actually feeling this negative emotion they made up something to understand it or deal with it. This is how a belief is made. The connection between the thought and the emotion. Sometimes people don't remember the actual event. It was so long ago and the negative belief has been running for so long that all they have the negative feelings and problems in the present day. Start with the symptoms of the problems today and it can still be resolved the same way.

You must be in actual real time contact with the intense emotion to be able to begin to change it. Hold onto the feeling while asking the feeling the question, “What is it you really want for me?”. By holding onto the negative feeling you stay able to feel. Then by asking the question you can feel the answer. Most insights you see are usually not enough. It is the feeling of the positive answer that allows you to transcend your current negative feelings. And as you feel yourself experiencing the positive feelings you also want to stay connected to the previous negative feelings that are now resolving. You are transcending and including your previous states of existence (see A Brief History of Everything by Ken Wilber). The original event has not changed. How you experience it has. You have changed your perspective through this emotional shift by feeling it and asking the question.

Or in other words: lemons into lemonade still has lemons in it. Transcend and include. When making lemonade you add things to it and now have a wonderful drink. It is important to note that unlike most goal setting programs with this cure you don't really get to pick how you want things to turn out. Most goal setting programs allow you to create anything out of your completely wild imagination and you get to have that. While you certainly have the right to buy anything with the money in your bank account it is illegal and immoral to purchase certain things. It is a type of standard such as this that you have to find for yourself with and with your feelings. Just as in making lemonade, if you don't add some type of sweetener to it you simply won't get lemonade. Certainly there are several types of sweetener that can be added and it doesn't really matter which ones you add. But there are types of sweeteners that are considered healthier than others. When you ask your feelings, “What is it you really want me to know?” you are receiving the healthiest answer through the negative feeling to have the most profound impact to become the healthiest person possible. Certainly other types of answers may come. And in some cases a lower level answer may be just enough to get by for now. If you are changing the deepest core belief then only the healthiest answer possible will change it forever. In this way letting the feeling deliver its own positive answer to you is far more valuable than creating (or forcing) the answer you want to hear.

Sometimes the connection to the emotion quickly comes and goes. Be quick yourself. The window of opportunity is very small sometimes. You have to be holding the feeling (currently experiencing it) as you ask your feeling the question through your own feelings, “What is it you really want for me?”.

When you ask a question and allow your feelings to answer while you feel it—you change your state. You may become vulnerable as you wait for the answer. Being able to wait for an answer (an answer that you are not dictating yourself) opens you to the opportunity to receive something different. In this state of feeling and suspension you are at your greatest state of being open to receiving something more, something different (change).

The act of waiting creates an opportunity through your own vulnerability where you become willing and able to change. It is similar to the emptiness described in various religions, philosophies, and cultures such as Zen Buddhism. You can feel yourself in this state of suspension. By coming from a state of pain in your negative feelings while seeking the positive intent you are also responsibly holding these two states of existence connected together in your conscious mind for complete and honest exchange. You feel the difference between the two and are able to receive the healthy positive feelings to live from there because you learned through a now positive experience what you really needed to know. Or in other words by being in the negative feeling while expecting the reason to come through you are connecting these two states of existence within yourself in such a way that had not existed before. By creating this bridge you are able to get the feelings to flow from the positive healthy side to the negative sick side within you. Relief is finally able to reach you because (on this one issue at least) you are on the healthy side now. Without creating this channel the positive healthy feelings wouldn't be able to really reach you to allow you to heal.

If you can't do it but are giving it your best effort then work on the opposite feeling (such as being a victim, coward, evasive, etc.). It is also helpful at this point to simply go looking for other feelings associated with your current state. Feelings can be interlaced like a spider web. Feel out how they are connected together and feel what needs to be felt in order to heel. Take some time at this point and go looking within your feelings to see what other feelings you are experiencing. If there is an evasiveness happening at this point it is often difficult for someone to find that unless you look for it. The first question to ask yourself is, “Are there other feelings I need to feel?” then “If there are what are these feelings” then “What is it that I don't want to feel about this?” It is best to remember to breathe to relax also during this (if you haven't been all along). It is by breathing to relax and be in the present moment that we have the greatest ability to fully experience the pain. It is during a state of relaxation that we are most aware. If different emotions are found then begin feeling them together. How do they want to be felt? What combinations of feelings fit best? As each set of feelings clicks then you can ask the final question with your feelings again, “What is it you really want me to know?”.

Work with their initial current range of emotions. What are you feeling now? This helps strengthen you to be able to deal with the most difficult horrendous emotional work that may come later. Just keep dealing with what is coming up now.

Asking the emotion—only underlying positive answers are true. Often the ego gives us negative answers. Keep going until you find the emotionally powerful positive answer. More than just feeling it, the experience, the awareness that it changes.

Thinking about the emotion is not the same as directly experiencing the emotion. Feel the emotion right as you ask it what it wants you to know. You begin to change as you get a positive answer that you can feel. Notice how your feeling has changed, if at all. If no change, then you got bamboozled by the feeling. Simple ask again, once you are actually feeling the emotion. Keep asking until you are clear that you got the real full lesson. You will feel the answer actually change you when the answer is good. Beware of shooting past the mark. If you keep asking after you got it trying to speed up the emotional growth then you destroy your recent success.

Using your conscience to find where they are lying (Ability to tell if people are lying, your conscious, reading emotion)

Looking for the false belief, the lie they've told themselves (for whatever reason)

It is their fault that they have a mental illness (or at least that they still have one), although to be fair the lie they told themselves that started this whole mess probably didn't seem like that bad of an idea at the time. It also delayed dealing with something that was far too difficult. Unfortunately the lie continued to grow. It doesn't stay hidden just like repressing things or denial doesn't stay down. Then the reason they believe the lie is also a lie.

It is also important to assess whether your feelings are telling the truth. Often we hear people refer to “their demons.” Seeing their truth, seeing beyond the lie, seeing what is real. We don't get to choose the answer!!! Only that we know that it will be something positive. When you are feeling the feeling and asking your question then you have to release all expectations. You have to let it tell you anything it needs too. You must surrender to it and humbly receive your answer. Only in humility will you have the capacity to receive the answer and then it can change you for the better. You probably don't have to worry if you are humble enough. Feeling one's feelings will humble you quickly enough. Only then will your deepest core beliefs begin to change. At this point, while relaxed (breathing), you can actually feel it is beginning to change. There is no room to lie to yourself, there is no room for the feeling to lie to you. You feel the change within you begin to completely change you. You feel it. You feel it become planted and slowly begin to grow. At this point, maybe for the first time in your life, you have room between action and reaction. The split second between the bell ringing and Pavlov's salivating dogs can bring the feelings of beginning to change within yourself. Now you can honor and respect the feeling by holding the space around it to give it room to let it grow without crushing it with analyzes or denial or over expectations (among other things). You honor and respect the space by letting the feeling grow. You let the feeling grow by allowing it to feel how it wants too. Then you get to feel it as it grows for the better. Just feel it and watch it. Even watch over it.

When we ask our emotion for what it is holding back from you it is very important to let it give its own answer to us. This way it is far more personal and it can change us easier. Let it tell you what you really need to know.

Often people try to impose their own “lessons” or make it say what they want to hear. You don't get to choose what your emotion gets re-framed too if you want to be healthy. That certainly doesn't mean you can't try. It's just that it's much less effective.

Every negative action has an underlying positive intent.

Start with what you are currently feeling. As you practice, stronger feelings will emerge to be dealt with. Since this in intense emotional work few people are going to be ready for it immediately. They need to build up their emotional strength. Sometimes (with extremely responsible support) experiential trainings involved with yelling and screaming can help build a person up. Unfortunately these same trainings, because they involve yelling and screaming, often cause more problems than they help with. To be so quickly immersed in such intense emotional pain can often be very destructive to a person. It can release such intense emotional pain that it can lead to more damage which makes the situation even worse. It can even lead to death including suicide. Most often it leads a person to disconnect from their current pain, a form of denial. This renders them detached (and a temporary relief is welcome). In order for this process to work best the person needs to be relaxed, calm, and coherent; self-aware without being self-conscious.

Once you are able to feel the meaning of what you are to learn then it is time to shift your focus to:

The strength to receive the answer.

Hold it (feeling the new feeling)

Recognizing the truth

Double check this new truth (ask again)

Sometimes the answers are pretty good but we need to be as sure as we can.

Meditating (reviewing, remembering the truth) especially feeling the answer.

Men and women may do the same process differently.

How male-female dynamics (see also enter into her heart process) can help alleviate so much pain and work. Then alleviating the pain can stop them from working and growing stronger.

Men tend to do better by processing internally. When men meditate as a means of doing this process and work through this internally it is more effective. Women tend to do better by talking it out. See differences between men and women.

Exercise helps a lot in reducing stress involved. (sex too of course.) Both of these things as well as other things such as food, alcohol, and drugs can lead into addiction.

Tracking—Spider web of emotions: At first this may be done with one emotion. Then it usually turns into how the one negative emotion is related and connected to all your other emotions. It can feel like a spider web. You pull on one strand and it affects the whole web. You follow the connection by feeling out how the emotion is connected to your other emotions.

Often times the complexity of your emotions make it difficult. It works much better to feel the emotions as they are originally laid out, regardless of how complex they are and experience them from the original event. This is an example of how remembering the event can be helpful in feeling it in order to change it. This will re-injure the person, of course, to feel the emotion from the event. Once the emotion is re-framed then this re-injury as well as the primary injury from the original negative traumatic event will be healed. Plus the subject is already suffering at the highest level by currently reliving the negative event and the negative emotions along with it already. It is only because you are able to heal that re-injuring a person is ever acceptable (see aversion therapy). Even if you know what to do it often times takes several work-throughs to completely change the belief that was formed. It is not that it isn't working—it is that it takes time build the strength to fully deal with the negative emotion. This is what the subject gains from the time spent reworking it through. It is through this work that the subject also gets the strength to regrow their healthy emotion.

What is claimed is:

1. A method for effecting changes in a subject's behavior or mental state comprising:
performing background and preparation work on the subject by engaging the subject in conversation and asking probing questions;
getting the subject to the point where the subject feels his or her emotions; and,
having the subject feel the emotion the way it wants to be felt.

2. The method of claim 1 further comprising the steps of:
having the subject feel the feeling fully and completely to completely “get it;”
having the subject find the answer the feeling really wants the subject to know by seeking through the feeling what is it the feeling really wants the subject to know;
when found then having the subject flow the positive feeling from the answer into the negative feeling (false belief) while staying relaxed and holding onto (staying within) the negative feeling(s); and,
having the subject tweak and adapt the positive feeling answer as the negative feeling (false belief) changes as needed to match until the negative feeling (false belief) completely transforms and is gone forever.

3. The method of claim 1 further comprising the step of engaging the subject in a dialogue.

4. The method of claim 3, further comprising the step of trust building with the subject.

5. The method of claim 4, further comprising the step of performing an initial assessment on the subject.

6. The method of claim 5 wherein the initial assessment is performed for the purpose of identifying the negative feeling (false belief) to be resolved

7. The method of claim 1 wherein the process involves asking the subject a series of questions and/or engaging in dialogue aimed at getting at the central events in the subject's past that are responsible for the subject's false beliefs and encouraging the subject to talk about the experiences and/or reflect upon the experiences until the subject fully feels the emotions associated with those experiences.

8. The method of claim 3 further comprising:
the responsibility phase;
the safety phase; including breathing techniques to relax and stay relaxed sharing the facts (crucial conversations or teaching the method);
Socratic questioning;
learning what the client's problem is;
understanding the subject; and
caring about the subject.

9. The method of claim 8 further comprising asking the subject at least one question from the following list: what therapy or personal growth the subject has already done, where the subject currently is at in their work, what is the subject's personal history; why is the subject seeking treatment; what problems is the subject experiencing; what symptoms is the subject experiencing; what help does the subject need; and, how does the subject feel the therapist can help him or her.

10. The method of claim 9 further comprising encouraging the subject to explore and express his or her feelings.

11. The method of claim 10 further comprising breathing exercises.

12. A method for effecting changes in a subject's behavior or mental state comprising the steps of:
an education phase comprising: Becoming familiar with some of the combined techniques set forth in the following sources: The Dark Side of the Light Chasers by Debbie Ford; The Shadow Effect by Deepak Chopra, Marianne Williamson and Debbie Ford; Crucial Conversations by Kerry Patterson, Joseph Grenny, Ron McMillan and Al Switzler; The Inner Game of Work by W. Timothy Gallwey; Inner Skiing: Mastering the Slopes Through Mind/Body Awareness by W. Timothy Gallwey; The Inner Game of Golf by W. Timothy Gallwey; Living Your Dreams Using Sleep To Solve Problems and Enrich Your Life by Gayle Delaney; A Brief History of Everything by Ken Wilber; Generations: The History of America's Future, 1584 to 2069 by William Strauss and Neil Howe; The Power of Now by Eckhart Tolle and A New Earth: Awakening to Your Life's Purpose by Eckhart Tolle; Feel the Fear and Do It Anyway by Susan Jeffers; Zen and the Art of Motorcycle Maintenance by Robert M. Pirsig; The Alchemist by Paulo Coelho; Ender's Game by Orson Scott Card; personal scripture; The Alcoholism & Addiction Cure: A Holistic Approach to Total Recovery by Chris Prentiss; The Awakening workshops taught by Gary Acevedo; NLP behavioural Modelling; Socratic questioning methods, especially those employed in sales techniques; Carl Rogers—person centered therapy; Fritz Pearls—gestalt; Cognitive Behavior Therapy; Albert Ellis—changing beliefs; Carl Jung—dark side of the soul with spirituality; John Gray—male/female dynamics; Allsion Armstrong—male-female dynamics; DiSC Personality Profiling (Myers-Briggs, Wealth Dynamics, etc.); Minnesota Multiphasic Personality Inventory (MMPI), Hartman Value Profile and other tests to determine actual mental health status;
a presession preparation phase;
caring about the subject.
an assessment phase;
understanding the subject;
the safety phase; including breathing techniques to relax and stay relaxed sharing the facts (crucial conversations or teaching the method);
Socratic questioning;
a trust building phase;
learning what the client's problem is;
the responsibility phase;
a crucial conversation phase; and
a critical question phase comprising:
having the subject feel the feeling fully and completely to completely “get it;”
having the subject find the answer the feeling really wants the subject to know by seeking through the feeling what is it the feeling really wants the subject to know;
when found then having the subject flow the positive feeling from the answer into the negative feeling (false belief) while staying relaxed and holding onto (staying within) the negative feeling(s); and,
having the subject tweak and adapt the positive feeling answer as the negative feeling (false belief) changes as needed to match until the negative feeling (false belief) completely transforms and is gone forever.

13. The method of claim 12
wherein the goal of the process is for the subject to achieve for personal or professional growth including emotional growth, spiritual growth, intellectual growth and physical growth.

14. The method of claim 12 wherein the goal of the process is to heal the subject (emotionally or physically)

15. The method of claim 12 wherein the goal of the process is to relieve suffering

16. The method claim 12 wherein the goal of the process is to help the subject problem solve.

17. The method of claim 12 wherein the goal of the process is to help the subject correct the past, make up for lost time, as if it never happened and so the subject is not affected by the negative events in the past anymore

18. The method of claim 12 wherein the goal is to change the subject's core beliefs to such a deep level that they operate at a gut level, instinctual knee jerk reaction

19. The method of claim 12 wherein the goal is to effect physical healing or a physical change in the subject.

20. The method of claim 12 wherein the goal is for the process to serve as a starting point in learning skills (ability to perform).

22. The method of claim 12 wherein the goal is to Affect the environment as well as the perspective and context of the subject.

23. The method of claim 12 wherein the process is used as a method of communication.
